(19) United States
(12) Patent Application Publication
(10) Pub. No.: US 2025/0258281 A1
(43) Pub. Date: Aug. 14, 2025

(54) LIDAR SYSTEM USING METASURFACE

(71) Applicant: HL KLEMOVE CORP., Incheon (KR)

(72) Inventor: Manwoo KIM, Incheon (KR)

(21) Appl. No.: 18/797,506

(22) Filed: Aug. 8, 2024

(30) Foreign Application Priority Data
Feb. 14, 2024 (KR) 10-2024-0021085

(51) Int. Cl. G01S 7/481

(52) U.S. Cl. CPC G01S 7/4817; G01S 7/4815

(57) ABSTRACT

A LiDAR system using a metasurface is provided. The LiDAR system according to an aspect of the present disclosure includes a first laser light source which radiates first laser light; a second laser light source which irradiates second laser light; a metasurface module for steering light that is irradiated from any one of the first laser light source and the second laser light source; and a controller for controlling a steering direction of light that is irradiated to a reflective surface of the metasurface module, wherein the first laser light irradiated from the first laser light source is reflected from the reflective surface of the metasurface module and scans a first angle range, and the second laser light irradiated from the second laser light source is reflected from the reflective surface of the metasurface module and scans a second angle range which is different from the first angle range.

### CROSS-REFERENCE TO RELATED APPLICATION

This application claims priority to and the benefit of Korean Patent Application No. 10-2024-0021085, filed on Feb. 14, 2024, the disclosure of which is incorporated herein by reference in its entirety.

### BACKGROUND

### 1. Technical Field

The present disclosure relates to a LiDAR system, and more specifically to a LiDAR system using a metasurface.

### 2. Discussion of Related Art

Tunable optical metasurface modules can be used for beam forming, including three-dimensional beam shaping, two-dimensional beam steering and one-dimensional beam steering. Generally, a metasurface module includes a plurality of optical structures that are operable to reflect, refract, steer, defocus, focus, converge and diverge optical radiation within an operating surface, along with tunable dielectric materials.

As illustrated in FIG. 1 of U.S. Registered U.S. Pat. No. 11,567,390, an example of tunable optical metasurface modules includes an array of long rails (e.g., resonators) that are arranged to be parallel to each other with respect to an optical reflector, such as an optically reflective metal layer or a Bragg reflector. The long rail arrays of such optical metasurface modules can be formed from metals, doped semiconductor materials and/or dielectric materials, and can be configured to have inter-element spacing of subwavelength.

Examples of suitable metals that can be used as optical reflectors and optical structures in metasurface modules include, but are not limited to, copper, aluminum, gold, silver, platinum, titanium and chromium. In the exemplary embodiments where the long rail array is fabricated from copper, the long copper rails may be formed by using, for example, a copper damascene manufacturing process. An example of such a metasurface module manufacturing process is disclosed, for example, in U.S. Pat. No. 10,698,522.

The LiDAR system disclosed in U.S. Registered U.S. Pat. No. 11,567,390 includes a metasurface module configuration as a LiDAR transmitter that is capable of selectively controlling an optical radiation source at a plurality of control angles, and particularly, it includes a tunable prism configuration to deflect the optical radiation produced by the optical radiation source for being incident on the metasurface module. In this case, the controller can individually address and selectively activate VCSELs, a row of VCSELs, a column of VCSELs or each VCSEL group of a subset of VCSELs.

However, in such a LiDAR system, the distortion of output light occurs depending on the steering angle of the metasurface module. The output light distorted into a curve in this way is difficult for receiving sensors that are arranged in a row to detect. The LiDAR system disclosed in U.S. Registered U.S. Pat. No. 11,567,390 uses a prism, which increases cost and size, in order to make various distortions symmetrical. In this case, in the LiDAR system disclosed in US Registered U.S. Pat. No. 11,567,390, the distortion of the transmitter is compensated by intentionally making the lens of the receiver distorted to correct the distorted output light with a curve that still exists even if a prism is used.

LiDAR systems using prisms in this way have the problems of increasing size and cost in order to eliminate the distortion of output light. In addition, there is a problem in that the lens of the receiver is intentionally distorted to compensate for the distortion that still occurs despite the use of a prism, thereby making the configuration complicated and increasing the cost.

### SUMMARY

The present disclosure has been devised to solve the above problems, and an object of the present disclosure is to provide a LiDAR system using a metasurface.

Another object of the present disclosure is to provide a LiDAR system that is compact in size and can reduce manufacturing costs by not using a prism.

Still another object of the present disclosure is to provide a LiDAR system using a metasurface that is configured to eliminate or minimize the distortion of output light.

The objects of the present disclosure are not limited to the above-described objects, and other objects that are not mentioned will be able to be clearly understood by those skilled in the art to which the present disclosure pertains from the following description.

According to an aspect of the present disclosure, provided is a LiDAR system using a metasurface, including a first laser light source for radiating first laser light; a second laser light source for irradiating second laser light; a metasurface module for steering light that is irradiated from any one of the first laser light source and the second laser light source; and a controller for controlling a steering direction of light that is irradiated to a reflective surface of the metasurface module, wherein the first laser light irradiated from the first laser light source is reflected from the reflective surface of the metasurface module and scans a first angle range, and wherein the second laser light irradiated from the second laser light source is reflected from the reflective surface of the metasurface module and scans a second angle range which is different from the first angle range.

In this case, the first laser light source and the second laser light source may be disposed on opposite sides with the metasurface module as the center.

In this case, the first laser light source, the metasurface and the second laser light source may be arranged in line.

In this case, the LiDAR system may further include a first beam splitter and a second beam splitter for polarizing the light irradiated from the first laser light source and the second laser light source, respectively.

In this case, a first plane including a reflective surface of the metasurface module and a second plane perpendicular to the irradiation direction of the first laser light source and the second laser light source may be disposed to be parallel to each other, and a light reflection member may be provided in front of the first laser light source and the second laser light source to reflect the first laser light and the second laser light to a surface of the metasurface module.

In this case, a first plane including a surface of the metasurface module and a second plane perpendicular to the irradiation direction of the first laser light source may be disposed to be inclined to each other such that the first laser light source is directed toward the surface of the metasurface module, and the second laser light source may be disposed to be symmetrical to the first laser light source with the metasurface module as the center.

In this case, the metasurface module, the first laser light source and the second laser light source may be mounted on one PCB board.

In this case, when the angle in a direction of being incident from the first laser light source to the surface of the metasurface module is −90 to 0 degrees with the surface of the metasurface module as the center based on a third plane that is perpendicular to the surface of the metasurface module and perpendicular to a direction in which the first laser light is irradiated to the surface of the metasurface module, the first angle range over which the first laser light scans may be a range between 0 and 90 degrees.

In this case, the second angle range over which the second laser light scans may be −90 to 0 degrees.

In this case, the first area scanned by the first laser light and the second area scanned by the second laser light may be each half of the entire scanning area range.

In this case, the controller may drive the first laser light source when scanning the first area, and drive the second laser light source when scanning the second area.

In this case, the controller may selectively drive any one of the first laser light source and the second laser light source when scanning a 0-degree area where the first area and the second area overlap.

In this case, the controller may sequentially drive the first laser light source and the second laser light source according to the steering order when sequentially steering the first area and the second area.

In this case, the controller may selectively drive the first laser light source or the second laser light source according to angle information to be steered among the first area and the second area.

In this case, the LiDAR system may further include a third laser light source which is disposed on a side of the first laser light source to irradiate third laser light; and a fourth laser light source which is disposed on a side of the second laser light source to irradiate fourth laser light.

According to another aspect of the present disclosure, provided is a LiDAR system using a metasurface, including a first laser light source for irradiating first laser light; a second laser light source for irradiating second laser light; a first beam splitter and a second beam splitter for respectively polarizing light that is irradiated from the first laser light source and the second laser light source; a metasurface module for steering light that is irradiated from any one of the first laser light source and the second laser light source; and a controller for controlling a steering direction of light that is irradiated to a reflective surface of the metasurface module, wherein the first laser light source and the second laser light source are disposed on opposite sides with the reflective surface of the metasurface module as the center.

In this case, the LiDAR system may further include a PCB board on which the metasurface module, the first laser light source and the second laser light source are mounted.

In this case, a light reflection member may be provided in front of the first laser light source and the second laser light source to reflect the first laser light and the second laser light to a surface of the metasurface module.

In this case, the first laser light irradiated from the first laser light source may be reflected from the metasurface module to scan a first angle range, the second laser light irradiated from the second laser light source may be reflected from the metasurface module and scans a second angle range that is different from the first angle range, and the first angle range may be a part of the entire range to be scanned, and the second angle range may be the remaining range.

In this case, when the entire angle range to be scanned is −α° to α°, the first area scanned by the first laser light may be a 0 to a° degree area in the angle range, and the second area scanned by the second laser light may be a −α° to 0-degree area in the angle range.

In this case, the controller may drive the first laser light source when scanning the first area, and drive the second laser light source when scanning the second area.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a schematic configuration diagram for explaining the basic structure of a metasurface module applied to a LiDAR system using a metasurface according to an exemplary embodiment of the present disclosure;

FIG. 2 is a diagram showing the distortion of light that occurs depending on the steering angle of the metasurface module;

FIG. 3 is a configuration diagram of a LiDAR system using a metasurface according to an exemplary embodiment of the present disclosure;

FIG. 4 is a diagram showing the area of light used in a LiDAR system using a metasurface according to an exemplary embodiment of the present disclosure;

FIG. 5 is a diagram showing the signal range of light used in a LiDAR system using a metasurface according to an exemplary embodiment of the present disclosure;

FIG. 6 is a diagram showing the light area used in the LiDAR system using a metasurface according to an exemplary embodiment of the present disclosure in the entire angle range;

FIG. 7 is an example of the method for controlling the operation of a LiDAR system using a metasurface according to an exemplary embodiment of the present disclosure;

FIG. 8 is another example of the method for controlling the operation of a LIDAR system using a metasurface according to an exemplary embodiment of the present disclosure;

FIG. 9 is a configuration diagram of a LiDAR system using a metasurface according to another exemplary embodiment of the present disclosure; and

FIG. 10 is a configuration diagram of a LiDAR system using a metasurface according to another exemplary embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

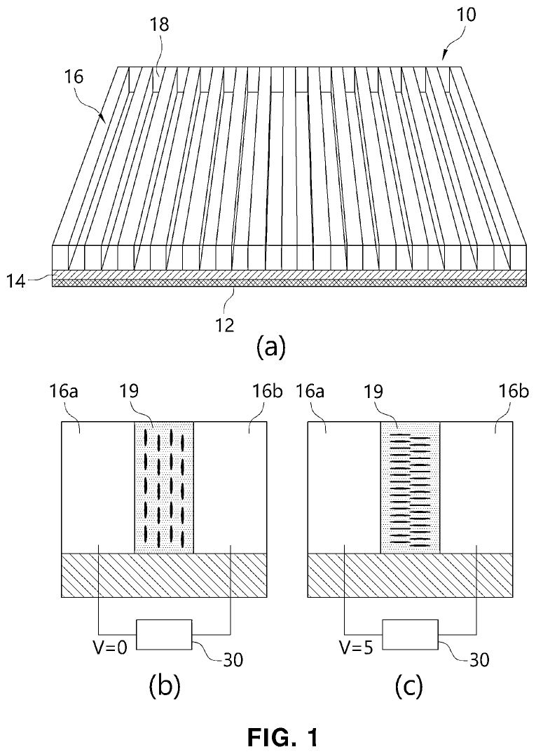

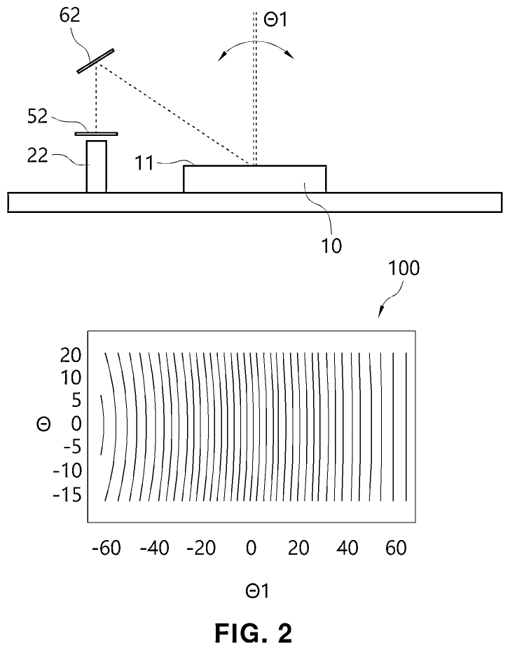

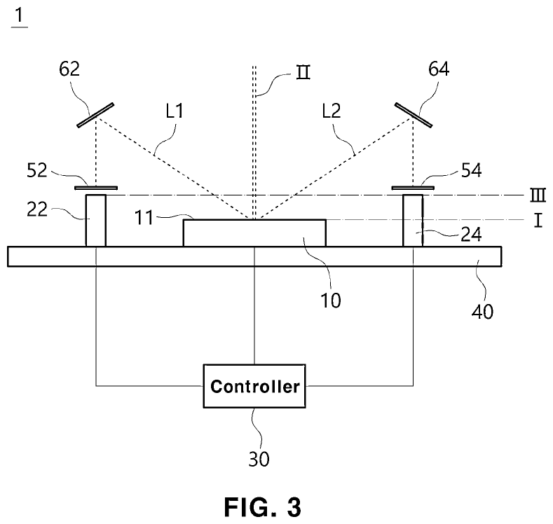

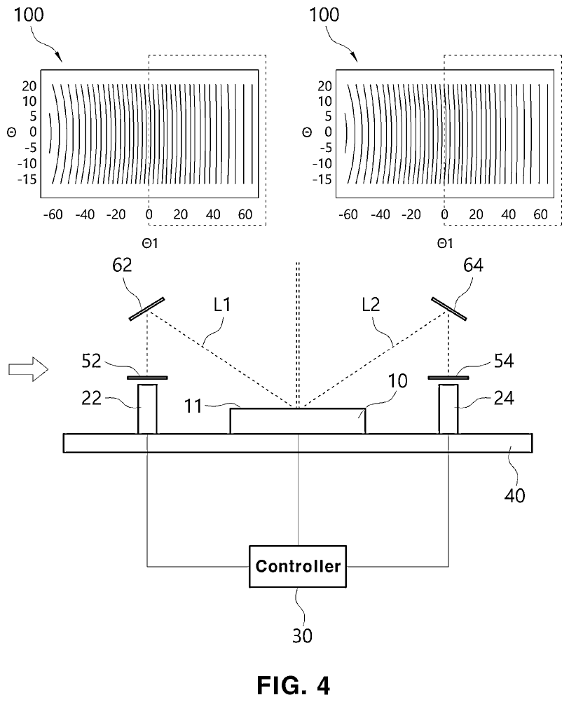

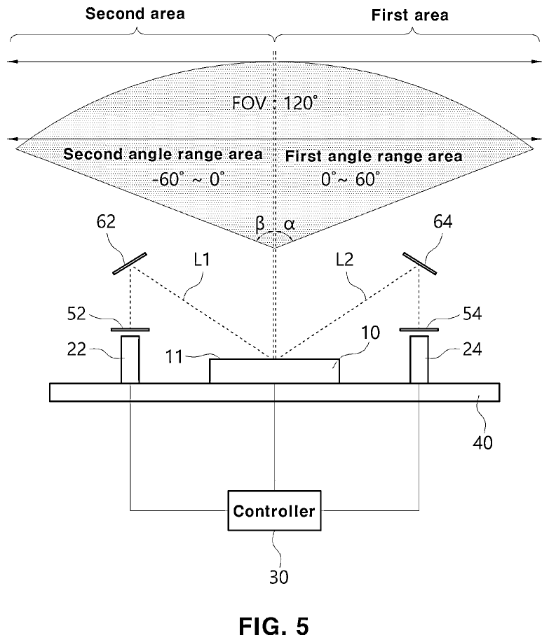

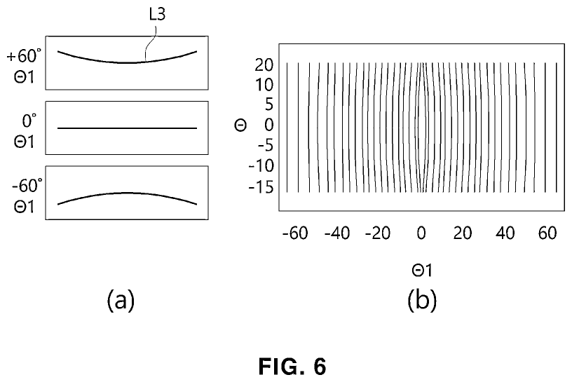

FIG. 1 is a schematic configuration diagram for explaining the basic structure of a metasurface module applied to a LiDAR system using a metasurface according to an exemplary embodiment of the present disclosure. FIG. 2 is a diagram showing the distortion of light that occurs depending on the steering angle of the metasurface module. FIG. 3 is a configuration diagram of a LiDAR system using a metasurface according to an exemplary embodiment of the present disclosure. FIG. 4 is a diagram showing the area of light used in a LiDAR system using a metasurface according to an exemplary embodiment of the present disclosure. FIG. 5 is a diagram showing the signal range of light used in a LiDAR system using a metasurface according to an exemplary embodiment of the present disclosure. FIG. 6 is a diagram showing the light area used in the LiDAR system using a metasurface according to an exemplary embodiment of the present disclosure in the entire angle range.

Referring to FIGS. 1 to 3, the LIDAR system 1 using a metasurface according to an exemplary embodiment of the present disclosure may include a metasurface module 10, a first laser light source 22, a second laser light source 24, a PCB board 40, a controller 30, first and second beam splitters 52, 54, and first and second reflection mirrors 62, 64.

The metasurface module 10 provides a surface for steering light that is irradiated from a light source. In an exemplary embodiment of the present disclosure, the metasurface module 10 may be mounted on a PCB board 40.

In an exemplary embodiment of the present disclosure, referring to FIG. 1(a), for example, the tunable metasurface module 10 may be used as part of a solid-state optical transmitter system, a receiver system or a transceiver system.

In this case, the tunable metasurface module 10 includes a light reflecting substrate 12 and a dielectric layer 14. A plurality of long rails 16 are arranged at sub-wavelength intervals on the light reflecting substrate 12 and are electrically separated by a dielectric layer 14.

In FIG. 1, a plurality of long rails 16 may be referred to as “resonator rails.” This is because the spacing between the plurality of long rails (filled with liquid crystal or another dielectric material that can be tuned to adjust the refractive index) resonates within the optical operating bandwidth of the tunable metasurface module 10.

In this case, another refractive index-tunable dielectric material 18 may be disposed between the long rails 16.

A controller or metasurface driver may apply voltage differential bias patterns to the long rail 16 so as to modify the reflection phase of the resonator (or the transmission phase of the resonator).

(b) of FIG. 1 is a block diagram of a liquid crystal 19 between two metal rails 16a, 16b according to an example of the tunable metasurface module, in an exemplary embodiment of the present disclosure.

As illustrated in (b) of FIG. 1, the liquid crystal may be aligned in a first direction corresponding to a first refractive index without voltage application by the voltage adjuster 17.

As illustrated in (c) of FIG. 1, when a voltage of 5 volts is applied to the liquid crystal 19 between two metal rails 16a, 16b according to an example of the tunable metasurface module, the liquid crystal 19 between the two metal rails 16a, 16b may be aligned in a second direction resulting in a second refractive index. The refractive index of the liquid crystal may change depending on the magnitude of the applied voltage.

The structure and operating method of the metasurface module 10 in this way are already known. For example, a metasurface module such as the “LM10 LCM module” manufactured and sold by LUMOTIVE may be used as a metasurface module 10 for a LiDAR system according to an exemplary embodiment of the present disclosure.

In the present specification, the detailed description of a detailed structure of the metasurface module 10 other than that described above will be omitted. However, it is not that only the “LM10 LCM module” which was illustratively described above can be used as a module having a reflective surface of the metasurface module 10 that can be used in the LiDAR system 1 according to an exemplary embodiment of the present disclosure, but those skilled in the art to which the present disclosure pertains will easily understand that as a known metasurface module 10, any metasurface module 10 may be applied to the LiDAR system of the present disclosure as long as it is a metasurface module 10 having a structure including a liquid crystal layer whose refractive index can be adjusted by applying a predetermined voltage.

Referring again to FIG. 3, in the LiDAR system 1 according to an exemplary embodiment of the present disclosure, a first laser light source 22 and a second laser light source 24 are disposed on a PCB board 40 on which the metasurface module 10 is mounted.

In this case, referring to FIG. 3, the first laser light source 22 and the second laser light source 24 may be disposed on opposite sides with the metasurface module 10 as the center.

Additionally, the first laser light source 22 and the second laser light source 24 may be disposed to be spaced apart from the metasurface module 10 at the same interval. In addition, the centers of the first laser light source 22, the metasurface module 10 and the second laser light source 24 may be arranged in line.

Accordingly, a first plane (I) including the reflective surface of the metasurface module 10 and a second plane (II) perpendicular to the irradiation direction of the first laser light source 22 and the second laser light source 24 may be arranged to be parallel to each other. In this case, a plane (III) to which the laser light source is irradiated may be arranged to be parallel to the first plane (I) and perpendicular to the second plane (II).

Accordingly, the laser light (L1, L2) irradiated by the first laser light source 22 and the second laser light source 24 is irradiated in a direction that is parallel to a direction in which the reflective surface 11 of the metasurface module 10 faces upward as seen in FIG. 3.

In this case, in an exemplary embodiment of the present disclosure, a first beam splitter 52 and a second beam splitter 54 are respectively provided in front of the first laser light source 22 and the second laser light source 24, that is, on the upper side as seen in in FIG. 3. The first beam splitter 52 and the second beam splitter 54 are configured to polarize light that is irradiated from the first laser light source 22 and the second laser light source 24, respectively.

Meanwhile, in an exemplary embodiment of the present disclosure, a first reflection mirror 62 and a second reflection mirror 64 are respectively disposed in front of the first laser light source 22 and the second laser light source 24, that is, on the upper side as seen in FIG. 3.

The first reflection mirror 62 and the second reflection mirror 64 respectively change the path of light such that the first laser light (L1) and the second laser light (L2) irradiated from the first laser light source 22 and the second laser light source 24 are directed to the reflective surface of the metasurface module 10.

Accordingly, the first laser light (L1) and the second laser light (L2) irradiated from the first laser light source 22 and the second laser light source 24 pass through the first beam splitter 52 and the second beam splitter 54, and are reflected by the first reflection mirror 62 and the second reflection mirror 64, and then are irradiated to the reflection surface 11 of the metasurface module 10.

In this case, the first laser light (L1) and the second laser light (L2) irradiated from the first laser light source 22 and the second laser light source 24 may be selected by the controller 30 according to the area to be scanned in the LiDAR system, and accordingly, they may be irradiated selectively or sequentially. The method for controlling the first laser light (L1) and the second laser light (L2) in the controller 30 of the LiDAR system will be described below.

In the LiDAR system 1 according to an exemplary embodiment of the present disclosure, FIG. 2 illustrates the range of straight and curved transmission scan lines 100 of the metasurface module 10 when there is no separate prism in front of the metasurface module 10.

As illustrated in FIG. 2, when a steering angle (θ1) is a negative steering angle, the transmit scan line 100 is a curved line, and it may be difficult to detect by a straight array of sensors in a LiDAR receiver or other sensor array.

In comparison, when the steering angle (θ1) is a positive steering angle, the transmission scan line 100 of the metasurface module 10 is more straight.

By focusing on the fact that the LiDAR system 1 according to an exemplary embodiment of the present disclosure has a straight transmission scan line in the positive steering angle range of the metasurface module 10 when there is no prism, the inventor of the present disclosure proposed a LiDAR system having a structure in which a pair of laser light sources that irradiate laser light to the metasurface module 10 are disposed on both sides of the metasurface module 10.

According to an exemplary embodiment of the present disclosure, when it is attempted to obtain a transmission scan line for the positive steering angle range for steering in the metasurface module 10 (a first area located to the right based on the center of the reflective surface of the metasurface module 10 as seen in FIG. 5), as seen in FIG. 5, the first angle range area (α) is scanned by using the first laser light (L1) irradiated from the first laser light source 22 located on the left side of the metasurface module 10 to obtain a transmission scan line.

In addition, when it is attempted to obtain a transmission scan line for the negative steering angle range for steering in the metasurface module 10 (a second area located to the left based on the center of the reflective surface 11 of the metal surface module 10 as seen in FIG. 5), as seen in FIG. 5, the second angle range area (β) is scanned by using the second laser light L2 irradiated from the second laser light source 24 located on the right side of the metasurface module 10 to obtain a transmission scan line.

In this case, for 0 degrees, a transmission scan line may be obtained by using any one of the first laser light (L1) or the second laser light (L2).

In this case, as an example, the Field of View (FOV) covered by the metasurface module 10 may be in the range of 120 degrees, and in this case, the first area may be a 0 to 60-degree range area (α), and the second area may be a −60 to 0-degree range area (β).

However, the ranges of the first area and second area may vary depending on the design. If the FOV is 60 degrees, the first laser light source may scan 0 to 30 degrees, and the second laser light source may scan −30 to 0 degrees.

As a related art, in the case of a metasurface with a prism applied to the LiDAR system disclosed in U.S. Registered U.S. Pat. No. 11,567,390, as illustrated in (a) of FIG. 6, straight and curved transmission scan lines (L3) are obtained, in which the scan line (L3) is a straight line at a steering angle of 0 degrees and becomes increasingly curved as the light radiation is steered in any direction.

In the LiDAR system disclosed in U.S. Registered U.S. Pat. No. 11,567,390, in order to correct the distortion of a transmission scan line, which is formed as a curved line as the light radiation direction moves away from 0 degrees, a receiving lens with additional barrel distortion is used to correct the line into a straight-line shape.

In comparison, when the LiDAR system 1 according to an exemplary embodiment of the present disclosure attempts to obtain a transmission scan line for the first area, a transmission scan line may be obtained by the first laser light (L1) irradiated from the first laser light source 22. In addition, when it attempts to obtain a transmission scan line for the second area, a transmission scan line may be obtained by the second laser light (L2) irradiated from the second laser light source 24.

Accordingly, as illustrated in (b) of FIG. 6, transmission scan lines that are nearly straight as a whole in the first area and the second area may be obtained at positive and negative steering angles. In this case, the interval between scan lines may become longer as the distance from 0 degrees increases, but the shape of the scan line becomes more straight as the distance increases.

As in an exemplary embodiment of the present disclosure, when the scan line is close to a straight line or when the FOV is small, only a scan line that is close to a straight line is generated, and thus, distortion may be corrected through a little calibration.

Therefore, the LiDAR system 1 according to an exemplary embodiment of the present disclosure may not include components with a large volume such as a prism, compared to the LiDAR system disclosed in US Registered U.S. Pat. No. 11,567,390.

In addition, the LiDAR system 1 according to an exemplary embodiment of the present disclosure may obtain a transmission scan line that is generally close to a straight line at positive and negative steering angles with the metasurface module 10 as the center without using a receiving lens with barrel distortion.

Accordingly, since the LiDAR system 1 according to an exemplary embodiment of the present disclosure can obtain a transmission scan line which is formed to have an overall straight line without using a prism and a receiving lens with barrel distortion, the overall volume of the LiDAR system may be reduced, the structure may be simple, and manufacturing costs may be reduced.

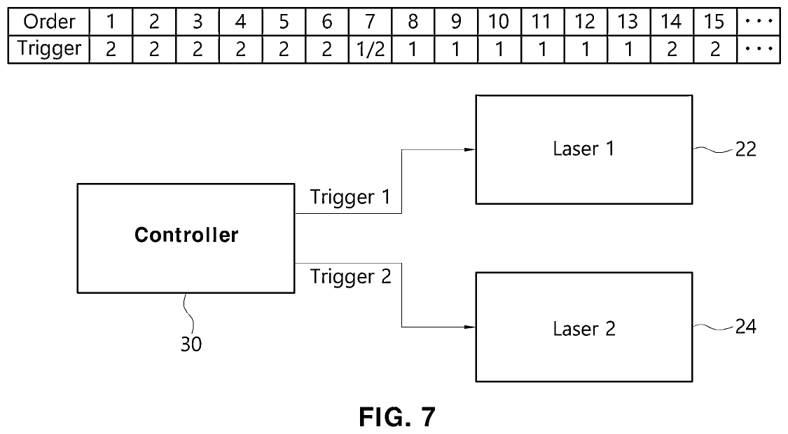

FIG. 7 is an example of the method for controlling the operation of a LiDAR system using a metasurface according to an exemplary embodiment of the present disclosure.

Referring to FIG. 7, as shown in Table 1 below, in the steering angle range of −60 to 0 degrees, the controller 30 controls to drive the second laser light source 24, and in the steering angle range of 0 to 60 degrees, the controller 30 controls to drive the first light source 22.

In this case, when the steering angle order is sequentially from −60 degrees to 0 degrees and 0 degrees to 60 degrees, the controller 30 may apply a trigger signal to sequentially drive the second laser light source 24 and the first laser light source 22.

TABLE 1

| Angle | Light Source |
|---|---|
| −60° | Laser 2 |
| −50° | Laser 2 |
| −40° | Laser 2 |
| −30° | Laser 2 |
| −20° | Laser 2 |
| −10° | Laser 2 |
| 0° | Laser 1 or Laser 2 |
| 10° | Laser 1 |
| 20° | Laser 1 |
| 30° | Laser 1 |
| 40° | Laser 1 |
| 50° | Laser 1 |
| 60° | Laser 1 |

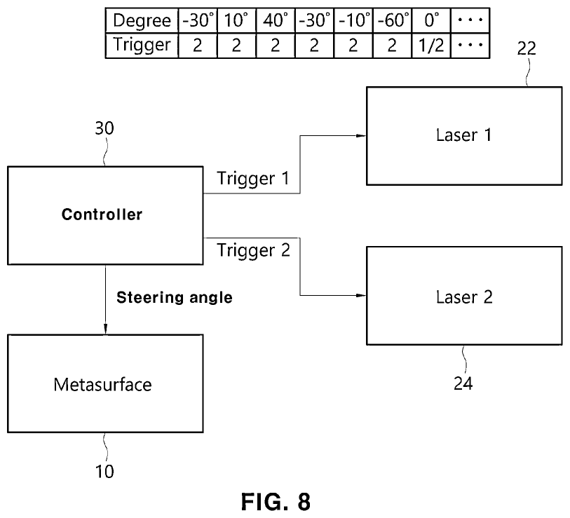

FIG. 8 is another example of the method for controlling the operation of a LIDAR system using a metasurface according to an exemplary embodiment of the present disclosure.

According to an exemplary embodiment of the present disclosure, the steering angles are not sequential as shown in FIG. 7, but as illustrated in FIG. 8, when the negative and positive areas are different each time, such as −30 degrees, 10 degrees, 40 degrees, −30 degrees and the like, or the steering angle to be irradiated is different, it is possible to selectively apply a trigger signal to the first laser light source 22 and the second laser light source 24, respectively, in which the controller 30 covers the corresponding steering angle range according to the steering angle signal that is input from a signal providing angle information.

In this case, since the control method in which the controller 30 applies a trigger signal to the first laser light source 22 and the second laser light source 24 to change the steering angle of the metasurface module can be achieved by using a known control method, the detailed description thereof will be omitted in the present specification.

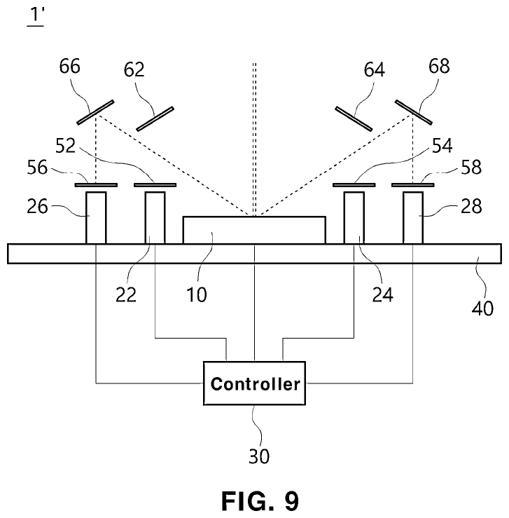

FIG. 9 is a configuration diagram of a LiDAR system 1′ using a metasurface according to another exemplary embodiment of the present disclosure.

Compared to the above-described LiDAR system, the LiDAR system 1′ using a metasurface according to another exemplary embodiment of the present disclosure includes 4 laser light sources, that is, first to fourth laser light sources 22, 24, 26, 28.

In this case, 4 laser light sources 22, 24, 26, 28 may be arranged two each on the left and right sides of the metasurface module 10 as illustrated in FIG. 9.

In order to polarize and reflect the light irradiated from each of the first to fourth laser light sources 22, 24, 26, 28, first to fourth beam splitters 52, 54, 456, 58 and first to fourth reflection mirrors 62, 64, 66, 68 may be installed in front of the first to fourth laser light sources 22, 24, 26, 28.

The arrangement of the first and second laser light sources 22, 24 and the third and fourth laser light sources 26, 28 may be varied with the metasurface module 10 as the center depending on the design. For example, the first to fourth laser light sources 22, 24, 26, 28 may be arranged in line similar to the above-described exemplary embodiment, but may not be arranged in line depending on the design. The arrangement of the first to fourth reflection mirrors 62, 64, 66, 68 may vary depending on the arrangement of the first to fourth laser light sources 22, 24, 26, 28.

In this way, when two or more laser light sources are installed on both sides of the metasurface module 10, by increasing the number of light sources, if the heating temperature of the light source is high compared to a case of installing one laser light source, the heating temperature may be lowered by irradiating the light sources alternately. Alternatively, the transmission output may be increased by simultaneously using two light sources located on the same side.

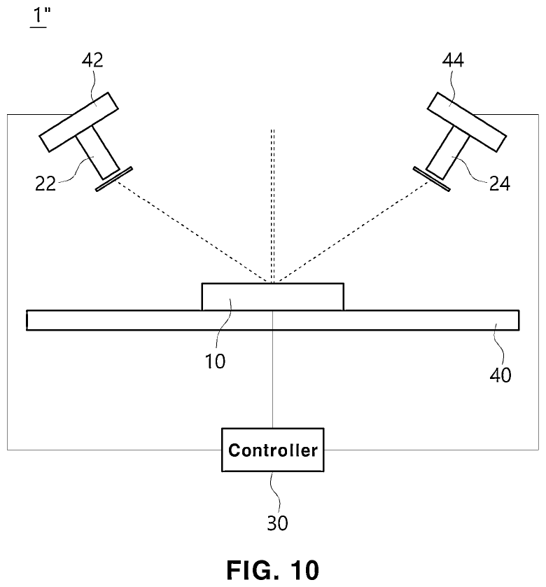

FIG. 10 is a configuration diagram of a LIDAR system (1″) using a metasurface according to another exemplary embodiment of the present disclosure.

Referring to FIG. 10, in the LiDAR system 1″ using a metasurface according to still another exemplary embodiment of the present disclosure, a first laser light source 22 and a second laser light source 24 for irradiating laser light are installed at the location where the reflection mirror is installed in the above-described exemplary embodiments.

In this case, a first frame 42 and a second frame 44 are provided to install the first laser light source 22 and the second laser light source 24 at the reflection mirror position.

In this case, the first and second frames 42, 44 may be separate components or may be different parts of a single component.

In this way, as another exemplary embodiment of the present disclosure, by removing the reflection mirror and installing the first laser light source 22 and the second laser light source 24 to be opposite to the metasurface module 10, it is possible to further increase the intensity of light that is irradiated to the metasurface module 10. Additionally, by reducing the size of the PCB board 40 on which the metasurface module 10 is mounted, the structure of the LiDAR system may be made more compact.

Accordingly, the LiDAR system 1″ according to another exemplary embodiment of the present disclosure may improve the design freedom of the LiDAR system

According to the above configurations, the LiDAR system according to an exemplary embodiment of the present disclosure does not have a prism-like configuration, but is provided with 2 light sources to transmit laser light to the metasurface module, and thus, only signals in areas where the distortion of output light does not occur may be used. Accordingly, the overall volume of the LiDAR system may be reduced, and production costs may be reduced.

The LiDAR system according to an exemplary embodiment of the present disclosure allows the light source that generates light transmitted to the metasurface module to be mounted together on the PCB board on which the metasurface module is mounted such that the overall size of the LiDAR system can be reduced.

In addition, the LIDAR system according to an exemplary embodiment of the present disclosure may be controlled to selectively transmit a plurality of lights transmitted to the metasurface.

It should be understood that the effects of the present disclosure are not limited to the above-described effects and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A LiDAR system using a metasurface, comprising:
a first laser light source for radiating first laser light;
a second laser light source for irradiating second laser light;
a metasurface module for steering light that is irradiated from any one of the first laser light source and the second laser light source; and
a controller for controlling a steering direction of light that is irradiated to a reflective surface of the metasurface module,
wherein the first laser light irradiated from the first laser light source is reflected from the reflective surface of the metasurface module and scans a first angle range, and
wherein the second laser light irradiated from the second laser light source is reflected from the reflective surface of the metasurface module and scans a second angle range which is different from the first angle range.

2. The LiDAR system of claim 1, wherein the first laser light source and the second laser light source are disposed on opposite sides with the metasurface module as the center.

3. The LiDAR system of claim 2, wherein the first laser light source, the metasurface and the second laser light source are arranged in line.

4. The LiDAR system of claim 2, further comprising:
a first beam splitter and a second beam splitter for polarizing the light irradiated from the first laser light source and the second laser light source, respectively.

5. The LiDAR system of claim 2, wherein a first plane including a reflective surface of the metasurface module and a second plane perpendicular to the irradiation direction of the first laser light source and the second laser light source are disposed to be parallel to each other, and
wherein a light reflection member is provided in front of the first laser light source and the second laser light source to reflect the first laser light and the second laser light to a surface of the metasurface module.

6. The LiDAR system of claim 2, wherein a first plane including a surface of the metasurface module and a second plane perpendicular to the irradiation direction of the first laser light source are disposed to be inclined to each other such that the first laser light source is directed toward the surface of the metasurface module, and
wherein the second laser light source is disposed to be symmetrical to the first laser light source with the metasurface module as the center.

7. The LiDAR system of claim 1, wherein the metasurface module, the first laser light source and the second laser light source are mounted on one PCB board.

8. The LiDAR system of claim 1, wherein when the angle in a direction of being incident from the first laser light source to the surface of the metasurface module is −90 to 0 degrees with the surface of the metasurface module as the center based on a third plane that is perpendicular to the surface of the metasurface module and perpendicular to a direction in which the first laser light is irradiated to the surface of the metasurface module, the first angle range over which the first laser light scans is a range between 0 and 90 degrees.

9. The LiDAR system of claim 8, wherein the second angle range over which the second laser light scans is −90 to 0 degrees.

10. The LiDAR system of claim 1, wherein the first area scanned by the first laser light and the second area scanned by the second laser light are each half of the entire scanning area range.

11. The LiDAR system of claim 10, wherein the controller drives the first laser light source when scanning the first area, and drives the second laser light source when scanning the second area.

12. The LiDAR system of claim 10, wherein the controller selectively drives any one of the first laser light source and the second laser light source when scanning a 0-degree area where the first area and the second area overlap.

13. The LiDAR system of claim 10, wherein the controller sequentially drives the first laser light source and the second laser light source according to the steering order when sequentially steering the first area and the second area.

14. The LiDAR system of claim 10, wherein the controller selectively drives the first laser light source or the second laser light source according to angle information to be steered among the first area and the second area.

15. The LiDAR system of claim 1, further comprising:
a third laser light source which is disposed on a side of the first laser light source to irradiate third laser light; and
a fourth laser light source which is disposed on a side of the second laser light source to irradiate fourth laser light.

16. A LIDAR system using a metasurface, comprising:
a first laser light source for irradiating first laser light;
a second laser light source for irradiating second laser light;
a first beam splitter and a second beam splitter for respectively polarizing light that is irradiated from the first laser light source and the second laser light source;
a metasurface module for steering light that is irradiated from any one of the first laser light source and the second laser light source; and
a controller for controlling a steering direction of light that is irradiated to a reflective surface of the metasurface module,
wherein the first laser light source and the second laser light source are disposed on opposite sides with the reflective surface of the metasurface module as the center.

17. The LiDAR system of claim 16, further comprising:
a PCB board on which the metasurface module, the first laser light source and the second laser light source are mounted.

18. The LiDAR system of claim 16, wherein a light reflection member is provided in front of the first laser light source and the second laser light source to reflect the first laser light and the second laser light to a surface of the metasurface module.

19. The LiDAR system of claim 16, wherein the first laser light irradiated from the first laser light source is reflected from the metasurface module to scan a first angle range,
wherein the second laser light irradiated from the second laser light source is reflected from the metasurface module and scans a second angle range that is different from the first angle range, and
wherein the first angle range is a part of the entire range to be scanned, and the second angle range is the remaining range.

20. The LiDAR system of claim 19, wherein when the entire angle range to be scanned is −α° to α°, the first area scanned by the first laser light is a 0 to α° degree area in the angle range, and the second area scanned by the second laser light is a −α° to 0-degree area in the angle range.
